(19) United States
(12) Patent Application Publication
(10) Pub. No.: US 2012/0281061 A1
(43) Pub. Date: Nov. 8, 2012

(54) TELECONFERENCE SYSTEM

(75) Inventor: Kazuya Tsujino, Osaka (JP)

(73) Assignee: SHARP KABUSHIKI KAISHA, Osaka-shi, Osaka (JP)

(21) Appl. No.: 13/522,187

(22) PCT Filed: Oct. 25, 2010
(86) PCT No.: PCT/JP2010/068856

§ 371 Date: Jul. 13, 2012

(30) Foreign Application Priority Data
Mar. 3, 2010 (JP) 2010-046759

(51) Int. Cl. H04N 7/14

(52) U.S. Cl. 348/14.08; 348/E07.077

(57) ABSTRACT

An aerial image forming portion forms, as an aerial image in space, an image of the other party's image displayed on a display device. A camera for shooting a user is placed at a position situated farther than the aerial image from the user. This makes it possible to reduce a deviation angle θ between the visual line direction of the user and the shooting direction of the camera to such an extent that the user feels substantially no visual line difference. Further, since the camera shoots the user directly, it is possible to shoot bright and natural-colored images.

### TECHNICAL FIELD

The present invention relates to a teleconference system that allows transmission and reception of images between distant locations.

### BACKGROUND ART

Generally, a teleconference system used for having a conference between distant locations includes, in each location, a camera for shooting a user and a display device for displaying the other party's images. And the teleconference system transmits signals of images shot by the camera to the other party, receives signals of the other party's images shot, and displays the other party's images on the display device.

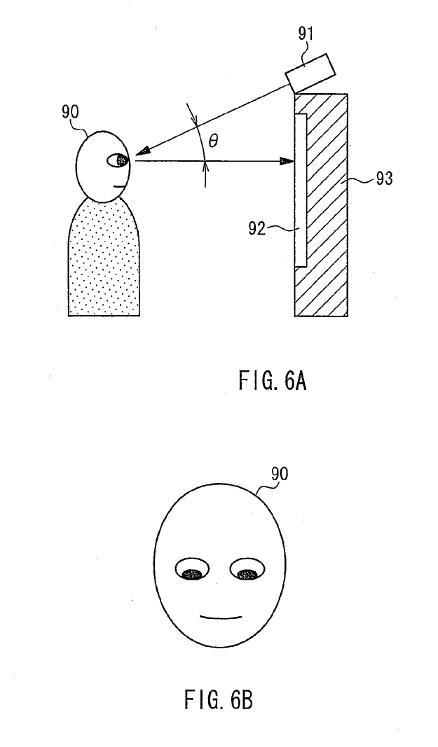

FIG. 6A is a diagram showing a schematic configuration of an exemplary conventional teleconference system. This teleconference system includes a camera 91 for shooting a user 90 and a display device 92 for displaying the other party's images. The camera 91 is placed at, for example, the upper edge of a cabinet 93 that holds the display device 92.

When having a conference, the user 90 normally looks at the other party's images displayed on the display device 92, particularly the other party's eyes, among others. Thus, the visual line direction of the user 90 and the shooting direction of the camera 91 do not coincide with each other, so that the both directions deviate from each other by an angle (deviation angle) θ. As a result, images of the user 90 shot by the camera 91 show the user 90 facing downward as shown in FIG. 6B, resulting in a problem of giving an odd impression to the other party.

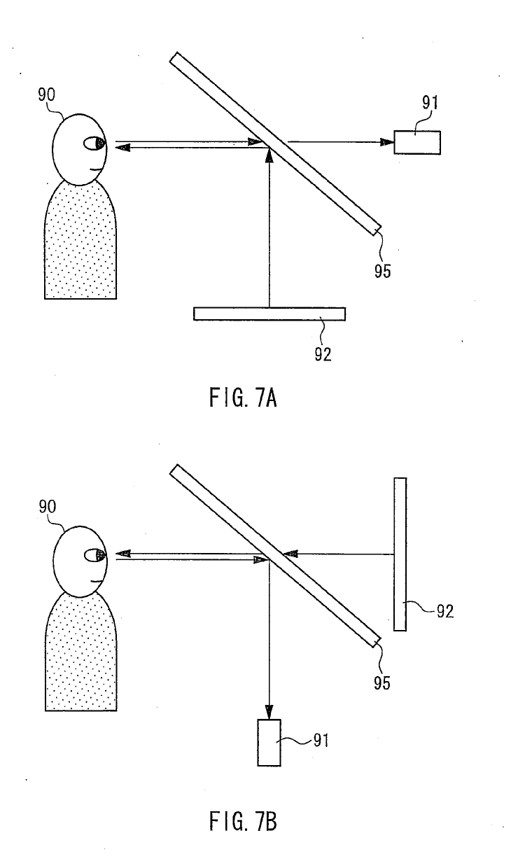

Conventional teleconference systems that solve the problem of the visual line difference as above will be explained with reference to FIGS. 7A and 7B (see Patent Documents 1 to 4, for example). In FIGS. 7A and 7B, the reference numeral 91 denotes a camera for shooting a user 90, the reference numeral 92 denotes a display device for displaying the other party's images, and the reference numeral 95 denotes an optical element, such as a half mirror, a polarized beam splitter, etc., that allows a part of incident light rays to pass therethrough but reflects the remainder of the light rays. In FIG. 7A, the camera 91 is placed right in front of the user 90 and shoots the user 90 through the optical element 95. Further, the user 90 visually identifies the other party's images, which are images displayed on the display device 92 and then reflected by the optical element 95. In FIG. 7B, the camera 91 shoots a reflected image of the user 90 reflected by the optical element 95. Further, the display device 92 is placed right in front of the user 90, and the user 90 visually identifies the other party's images displayed on the display device 92 through the optical element 95.

In the teleconference systems shown in FIGS. 7A and 7B, it is possible to substantially coincide with each other the visual line direction in which the user 90 looks at the display device 92 and the direction in which the camera 91 shoots the user 90.

### PRIOR ART DOCUMENTS

### Patent Documents

Patent Document 1: JP 61-171364 U

Patent Document 2: JP 11-122592 A

Patent Document 3: JP 11-177949 A

Patent Document 4: JP 2007-28663 A

Patent Document 5: JP 2008-158114 A

Patent Document 6: JP 2009-75483 A

Patent Document 7: JP 2001-255493 A

### Non-Patent Document

Non-Patent Document 1: Shinichi Shiwa et al., “Eye Contact Display Technologies for Visual Telecommunications”, NTT R&D, vol. 42, No. 1,1993, pp. 45 to 52

### SUMMARY OF INVENTION

### Problem to be Solved by the Invention

The optical element 95 used in the teleconference systems shown in FIGS. 7A and 7B separates incident light into transmitted light and reflected light, and only one of the transmitted light and the reflected light is incident to the camera 91. That is, in FIG. 7A, a part of light from the user 90 is reflected by the optical element 95 and only the remainder of the light that has passed through the optical element 95 is incident to the camera 91. Further, in FIG. 7B, a part of light from the user 90 passes through the optical element 95 and only the remainder of the light that has been reflected by the optical element 95 is incident to the camera 91. Therefore, in either case, the amount of incident light to the camera 91 becomes smaller than that in shooting the user 90 directly with the camera 91 without the optical element 95, resulting in a problem of darkening of shot images.

Further, since the optical element 95, such as a half mirror, a polarized beam splitter, etc., generally has wavelength dependence, images shot by the camera 91 have an unnatural color, resulting in a problem of images displayed to the other party being of poor image quality.

An object of the present invention is to provide a teleconference system in which the problems associated with the conventional teleconference systems are solved, a user feels no feeling of strangeness resulting from a visual line difference, and bright and natural-colored images can be shot.

### Means for Solving Problem

The teleconference system of the present invention is a teleconference system including a camera for shooting a user and a display device for displaying the other party's image. The teleconference system further includes an aerial image forming portion for forming, as an aerial image in space, an image of the other party's image displayed on the display device, and the camera is placed at a position situated farther than the aerial image from the user.

### Effects of the Invention

According to the present invention, an image of the other party's image is formed as an aerial image, and the camera is placed at a position situated farther than the aerial image from the user. This makes it possible to reduce the deviation angle θ between the visual line direction of the user and the shooting direction of the camera to such an extent that the user substantially feels no visual line difference.

Further, since the camera can shoot the user directly without an optical element such as a half mirror, a polarized beam splitter, etc., it is possible to shoot bright and natural-colored images and these images can be displayed on the other party's display device.

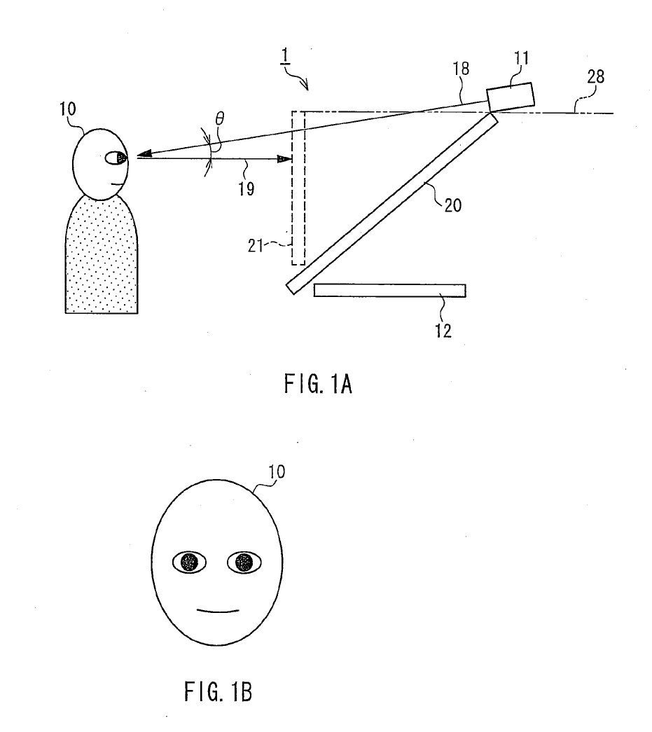

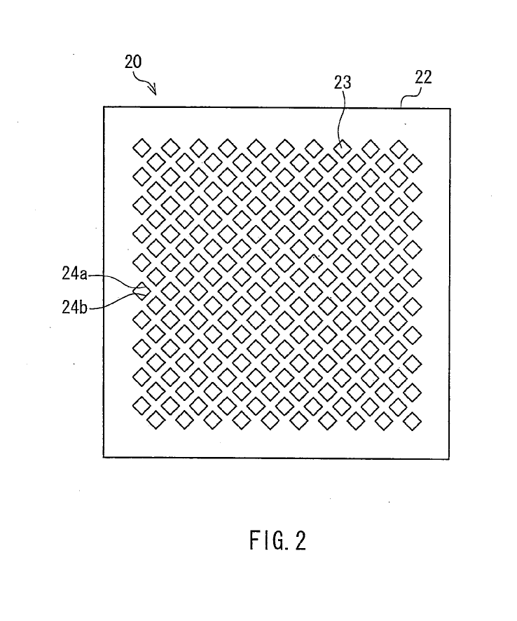

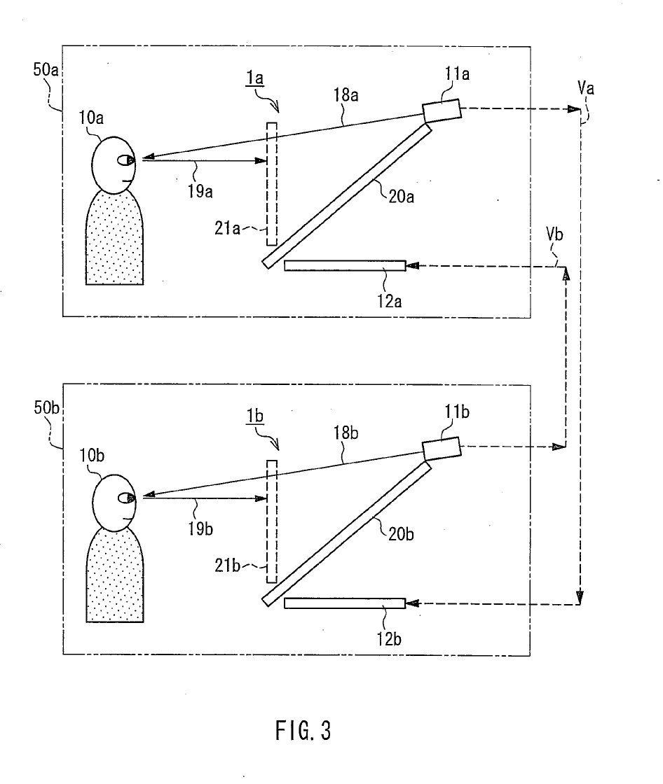

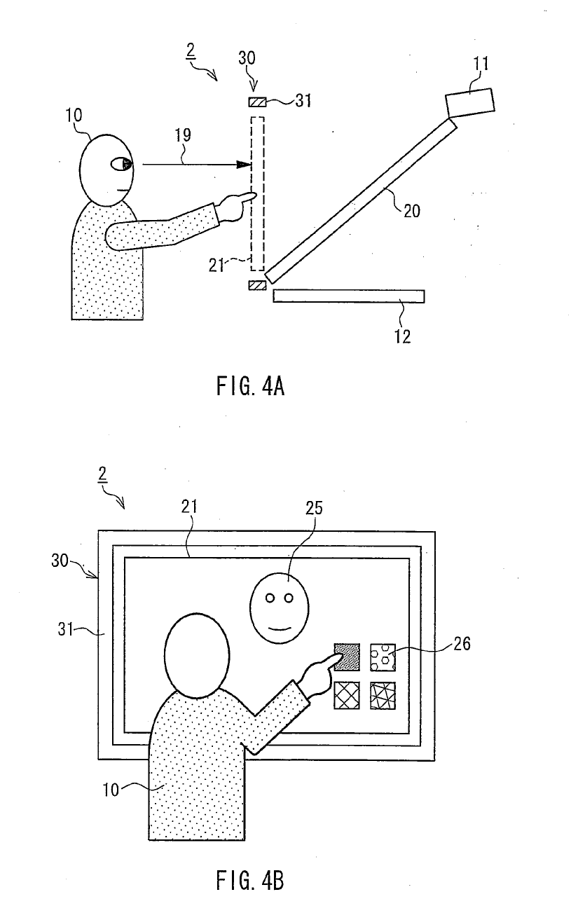

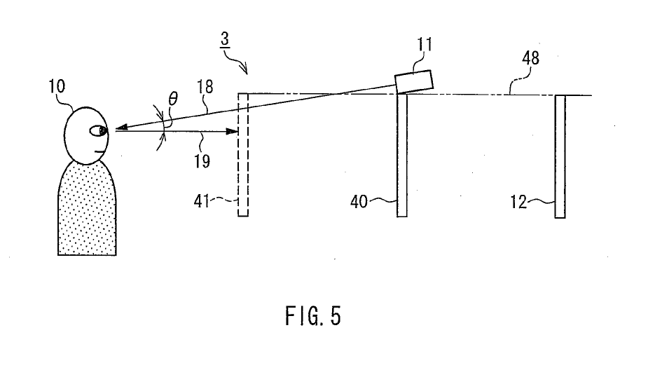

### BRIEF DESCRIPTION OF THE DRAWINGS

[FIG. 1] FIG. 1A is a diagram showing a schematic configuration of a teleconference system according to Embodiment 1 of the present invention. FIG. 1B is a diagram showing an image of a user shot by a camera in the teleconference system shown in FIG. 1A.

[FIG. 2] FIG. 2 is a plan view showing a schematic configuration of a reflective imaging element used as the aerial image forming portion of the teleconference system according to Embodiment 1 of the present invention.

[FIG. 3] FIG. 3 is a diagram showing an example of use of the teleconference system according to Embodiment 1 of the present invention.

[FIG. 4] FIG. 4A is a side view showing a schematic configuration of a teleconference system according to Embodiment 2 of the present invention. FIG. 4B is a plan view of the teleconference system according to Embodiment 2 of the present invention from the user side.

[FIG. 5] FIG. 5 is a diagram showing a schematic configuration of a teleconference system according to Embodiment 3 of the present invention.

[FIG. 6] FIG. 6A is a diagram showing a schematic configuration of an exemplary conventional teleconference system. FIG. 6B is a diagram showing an image of a user shot by a camera in the teleconference system shown in FIG. 6A.

[FIG. 7] FIG. 7A is a diagram showing a schematic configuration of an exemplary conventional teleconference system capable of coinciding visual lines. FIG. 7B is a diagram showing a schematic configuration of other exemplary conventional teleconference system capable of coinciding visual lines.

### DESCRIPTION OF THE INVENTION

Generally, in order not to let the user feel a visual line difference in a teleconference system, a deviation angle (the deviation angle θ in FIG. 6A) between the visual line direction of the user and the shooting direction of the camera does not need to be exact 0 but it is considered that the deviation angle only needs to be about 3° or less in both the vertical direction and the horizontal direction (see Non-Patent Document 1). Therefore, if the deviation angle θ between the visual line direction of the user and the shooting direction of the camera can be set to 3° or less, a teleconference system in which the user feels substantially no visual line difference can be achieved.

To reduce the deviation angle θ, for example, the other party's face may be displayed at a position close to the upper end of the display screen of the display device 92 so that the position of the other party's eyes displayed on the display device 92 is brought closer to the camera 91. However, the other party's such images are unnatural. Further, since the display device 92 has a so-called “frame” around the display screen, there is a limit in reducing the deviation angle θ even if the other party's face is displayed near the upper end of the display screen.

For these reasons, the teleconference system of the present invention includes the aerial image forming portion for forming, as an aerial image in space, the other party's image. And the camera is placed at a position situated farther than the aerial image from the user. This makes it possible to reduce the deviation angle θ between the visual line direction of the user and the shooting direction of the camera to 3° or less, at which the user would feel substantially no visual line difference. Furthermore, since the camera can shoot the user directly unlike in the conventional teleconference systems shown in FIGS. 7A and 7B, it is possible to shoot bright and natural-colored images.

In the teleconference system of the present invention, it is preferable that the camera is placed at or near an edge of the aerial image forming portion. This makes it possible to further reduce the deviation angle θ between the visual line direction of the user and the shooting direction of the camera. Moreover, since the camera and the aerial image forming portion can be combined into one piece, it is possible to achieve a teleconference system that can be set up with ease before start using it. Generally, the other party's eyes appeared in the aerial image are situated closest to the upper side of the four surrounding sides of the aerial image. For this reason, it is preferable that the camera is placed at or near the upper edge of the aerial image forming portion.

It is preferable that the camera shoots the user through an area in which the aerial image is formed. This makes it possible to further reduce the deviation angle θ between the visual line direction of the user and the shooting direction of the camera.

It is preferable that the aerial image forming portion includes a reflective imaging element for forming the image of the other party's image displayed on the display device at a position plane-symmetrical to the other party's image.

Or, it is preferable that the aerial image forming portion includes a microlens array placed between the display device and the user. In this case, it is preferable that the microlens array forms, on the opposite side to the display device, the image of the other party's image displayed on the display device.

It is preferable that the teleconference system of the present invention further includes a touch input device placed between the aerial image forming portion and the user. This makes it possible to achieve a teleconference system in which information can be inputted by an intuitive operation; touching the aerial image with a finger.

Hereinafter, the present invention will be described in detail by way of preferred embodiments. It should be noted that the present invention is not limited to the following embodiments. Each of the drawings referred to in the explanations below illustrates, in a simple manner, only the main components necessary in explaining the present invention. Thus, the present invention may include components not illustrated in each of the drawings as needed. Further, the dimensions of the components in each of the drawings may not represent the actual dimensions of the components or the proportions in dimensions of the respective components.

### Embodiment 1

FIG. 1A is a diagram showing a schematic configuration of a teleconference system 1 according to Embodiment 1 of the present invention. The teleconference system 1 includes a camera (video camera) 11 for shooting a user 10, a display device 12 for displaying the other party's image, and a reflective imaging element 20 as an aerial image forming portion for forming, as an aerial image 21 in space, an image of the other party's image displayed on the display device 21.

There is no particular limitation to the camera 11, and it is possible to use, for example, any known cameras equipped with a CCD, a C-MOS, an image pickup tube and the like used in teleconference systems.

There is no particular limitation to the display device 12, and it is possible to use any known display devices used in teleconference systems, such as liquid crystal displays, plasma displays, EL (Electro Luminescence) display elements, and CRT displays.

As shown in FIG. 2, the reflective imaging element (sometimes referred to as “dihedral corner reflector array”) 20 includes a thin plate 22 about 50 to 200 μm in thickness, and many through holes 23 rectangular (preferably square) in plan view are formed in the thin plate 22 (see Patent Documents 5, 6, for example). One side of the rectangle formed by each through hole 23 is about 50 to 200 μm. Of the four internal surfaces forming each through hole 23, two adjacent and orthogonal surfaces are mirror finished or the like to serve as reflecting surfaces 24a, 24b. The reflecting surfaces 24a of the many through holes 23 are parallel to each other, and the reflecting surfaces 24b of the many through holes 23 are parallel to each other. Light incident to each through hole 23 from one side of the thin plate 22 is reflected by one of the reflecting surfaces 24a, 24b, is further reflected by the other of the reflecting surfaces 24a, 24b, and exits each through hole 23 from the other side of the thin plate 22.

When such a reflective imaging element 20 is placed diagonally with respect to the display screen of the display device 12 as shown in FIG. 1A, a real image (real mirror image) of an image (the other party's image) displayed on the display screen of the display device 12 is formed as the aerial image 21 at an aerial position plane-symmetrical to the display screen of the display device 12 with respect to the reflective imaging element 20. The user 10 sets his visual line to the other party's eyes appeared in the aerial image 21.

In FIG. 1A, to form in the visual line direction 19 of the user 10 the aerial image 21 in a plane perpendicular to the visual line direction 19, the reflective imaging element 20 may be placed, for example, with a tilt of 45° with respect to the visual line direction 19 of the user 10. At this time, the display screen of the display device 12 can be placed parallel to the visual line direction 19.

On the other hand, it is preferable that the camera 11 is placed at a position where the angle (deviation angle) θ between the visual line direction 19 of the user 10 and the shooting direction 18 of the camera 11 becomes as small as possible. To do so, first, it is preferable that the distance between the camera 11 and a line along the visual line direction 19 is as small as possible. Second, it is preferable that in the visual line direction 19 the camera 11 is distanced from the user 10 as farther as possible. Third, it is preferable that the camera 11 does not cast its shadow on the aerial image 21. From such viewpoints, the camera 11 can be placed, for example, at or near the edge of the reflective imaging element 20 situated most farther from the user 10 (the upper edge in FIG. 1A). This allows a cabinet (not shown) for holding the display device 12 and the reflective imaging element 20 to also hold the camera 11, so that an all-in-one teleconference system can be achieved.

According to the present embodiment, the deviation angle θ between the visual line direction 19 of the user 10 and the shooting direction 18 of the camera 11 cannot be eliminated completely. However, as is clear from a comparison between FIG. 6A showing the conventional teleconference system and FIG. 1A, in the present embodiment, the camera 11 can be placed at a position situated farther than the position for forming the aerial image 21 in which the other party's image appears. Thus, in the present embodiment (FIG. 1A), it is possible to reduce the deviation angle θ between the visual line direction 19 of the user 10 and the shooting direction 18 of the camera 11 more easily than in the conventional system (FIG. 6A). Consequently, as shown in FIG. 1B, the camera 11 can shoot a front image of the user 10 in which his visual line is set to the other party's eyes in the aerial image 21.

Further, the camera 11 shoots the user 10 directly. Thus, the problems associated with the conventional teleconference systems shown in FIGS. 7A and 7B, such as the amount of incident light to the camera being small and the color of images shot by the camera being unnatural, do not arise in the present embodiment, so that it is possible to shoot bright and natural-colored images of high picture quality.

In the area in which the aerial image 21 is formed, there is no obstacle to the camera 11 in shooting the user 10. Therefore, the camera 11 can shoot the user 10 though the area in which the aerial image 21 is formed. This makes it possible to further reduce the deviation angle θ.

The effects of Embodiment 1 will be explained by way of a specific numerical example.

Consideration is given to the following teleconference system; in this teleconference system, when having a conference, the user looks at the other party's image displayed in an image display area that is 50 cm apart from the user in the horizontal direction and is parallel to the vertical direction. The aspect ratio and the diagonal size of the image display area are 16:9 and 26 inches, respectively. The vertical position of the other party's eyes displayed in the image display area is 5 cm below the upper edge of the image display area, and the user sets his visual line to the other party's eyes displayed.

Given that such a teleconference system is configured using the conventional teleconference system shown in FIG. 6A and that the camera 91 is placed at the upper edge of the image display area, the deviation angle θ is 5.7° (=tan⁻¹(5 /50)). However, it is generally difficult to place the camera 91 at the upper edge of the image display area because, in reality, there is a frame around the image display area (i.e., display screen) of the display device 92. Thus, the deviation angle θ becomes much larger than 5.7°. For these reasons, the conventional teleconference system shown in FIG. 6A cannot solve the problem of visual line difference.

In contrast, to configure the above-described teleconference system in the present embodiment, the aerial image 21 may be formed at a position 50 cm apart from the user 10 in FIG. 1A. The display screen of the display device 12 is placed parallel to a horizontal plane, and the reflective imaging element 20 is placed with a tilt of 45° with respect to a horizontal plane. The size of the display device 12 along the visual line direction 19 is about 57 cm. The vertical position of the upper edge of the reflective imaging element 20 is the same as or higher than that of the upper end of the area in which the aerial image 21 is formed. The alternate long and two short dashes line 28 indicates a horizontal plane passing the upper end of the area in which the aerial image 21 is formed. The camera 11 is placed at the upper edge of the reflective imaging element 20. Given that the vertical position at which the camera 11 is placed is the same as that of the upper edge of the area in which the aerial image 21 is formed, the deviation angle θ is 2.7° (=tan⁻¹ [5/(50+57)]), which is smaller than 3° as the upper limit to the deviation angle θ at which the user would feel substantially no visual line difference.

In the reflective imaging element 20, there is generally an area with no hole around the area in which the many through holes 23 are formed (see FIG. 2). Thus, in reality, the vertical position at which the camera 11 is placed may need to be set higher than the horizontal plane 28 passing the upper end of the area in which the aerial image 21 is formed. Even in such a case, it is possible to adequately reduce the deviation angle θ to 3° or less by bringing the camera 11 closer to the horizontal plane 28 as much as possible.

Therefore, according to the present embodiment, it is possible to achieve a teleconference system in which the user feels no feeling of strangeness resulting from a visual line difference.

FIG. 3 shows an example of use of the teleconference system 1 according to the present embodiment. The teleconference systems 1a, 1b according to the present embodiment described above are respectively placed in conference rooms 50a, 50b that are distant from each other. The teleconference systems 1a, 1b placed in the conference rooms 50a, 50b, respectively, are configured in the same manner as the teleconference system 1 described above. However, in order to distinguish one teleconference system from the other, the reference numerals denoting the components in the conference room 50a are accompanied with the letter “a”, and the reference numerals denoting the components in the conference room 50b are accompanied with the letter “b”.

The camera 11a in the conference room 50a shoots the user 10a. Image signals Va outputted from the camera 11a are supplied to the display device 12b in the conference room 50b via a communication network (not shown). An image of the user 10a's image displayed on the display device 12b is formed as an aerial image 21b by the aerial image forming portion 20b.

Similarly, the camera 11b in the conference room 50b shoots the user 10b. Image signals Vb outputted from the camera 11b are supplied to the display device 12a in the conference room 50a via the communication network (not shown). An image of the user 10b's image displayed on the display device 12a is formed as an aerial image 21a by the aerial image forming portion 20a.

Although not being shown, a microphone and an audio reproducer are placed in each of the conference rooms 50a, 50b. Audio information obtained through the microphone placed in one of the conference rooms 50a, 50b is supplied to the audio reproducer placed in the other conference room via the communication network (not shown), and is reproduced.

By means of the above configuration, the user 10a in the conference room 50a and the user 10b in the conference room 50b can each look at and listen to images and audio of the other party at a distant location.

In FIG. 3, an example of having a teleconference between two locations is shown. It should be noted, however, that the present invention is not limited to this example. By placing the teleconference systems in three or more different locations and connecting these teleconference systems via a communication network, it is also possible to have a teleconference among three or more locations. Further, by placing a plurality of teleconference systems in the same conference room, a plurality of users in the same conference room can have a teleconference at the same time with a user in a different conference room.

### Embodiment 2

FIG. 4A is a side view showing a schematic configuration of a teleconference system 2 according to Embodiment 2 of the present invention, and FIG. 4B is a plan view of the schematic configuration from the user 10 side. It should be noted that the same members as in the teleconference system 1 according to Embodiment 1 (see FIG. 1A) are denoted by the same reference numerals and detailed description thereof will not be repeated.

In the teleconference system 2 according to the present invention, an infrared touch input device (touch screen) 30 is further added to the teleconference system 1 according to Embodiment 1.

The infrared touch input device 30 includes a substantially-rectangular frame 31. Within the opening surrounded by the frame 31, many infrared rays are emitted in the vertical direction and the horizontal direction in a lattice-like manner. When the user 10 puts his finger in the opening of the frame 31, infrared rays are disrupted. By detecting the disrupted infrared rays, the position of the finger can be detected. There is no particular limitation to the specific configuration of the infrared touch input device 30, and a known infrared touch input device may be used.

As shown in FIG. 4A, in the visual line direction 19 of the user 10, the touch input device 30 is placed between the user 10 and the reflective imaging element 20, preferably at the position at which the aerial image 21 is formed. The camera 11 can shoot the user 10 through the opening of the frame 31 of the touch input device 30. Further, as shown in FIG. 4B, the touch input device 30 is placed such that the aerial image 21 is surrounded by the frame 31 of the touch input device 30 from the user 10's view.

As shown in FIG. 4B, in addition to the other party's image 25, a variety of selection buttons 26 can be displayed as the aerial image 21 within the frame 31 of the touch input device 30. When the user 10 acts to touch the selection button 26 appeared in the aerial image 21 with his finger, the touch input device 10 detects this action and allows an input of certain information.

In this way, according to the present embodiment, it is possible to achieve a teleconference system in which information can be inputted by an intuitive and natural action; touching the displayed aerial image 21 with a finger or the like.

If the input information is transmitted to the other party, it is possible to communicate with the other party with ease. Further, a variety of settings of the teleconference system may be changed based on the input information.

It should be noted that the touch input device 30 is not limited to an infrared touch input device. Any known touch input devices including a substantially-transparent plate-like panel, for example, resistive, surface acoustic wave, capacitative and electromagnetic induction touch input devices, can be used. Further, it is also possible to use an image recognition touch input device that shoots a user's finger with an image sensor and detects the position of the finger.

### Embodiment 3

FIG. 5 is a diagram showing a schematic configuration of a teleconference system 3 according to Embodiment 3 of the present invention. It should be noted that the same members as in the teleconference system 1 according to Embodiment 1 (see FIG. 1A) are denoted by the same reference numerals and detailed description thereof will not be repeated.

The teleconference system 3 includes a camera (video camera) 11 for shooting a user 10, a display device 12 for displaying the other party's image, and a microlens array 40 as an aerial image forming portion for forming, as an aerial image 41 in space, an image of the other party's image displayed on the display device 12. The teleconference system 3 according to the present embodiment is different from the teleconference system 1 according to Embodiment 1 in the use of the microlens array 40 as the aerial image forming portion.

The microlens array 40 includes a transparent flat plate, and a plurality of microsize convex lenses (microlenses) are disposed two-dimensionally on one side or both sides of the transparent flat plate. A plurality of microlens arrays that are parallel to each other may be used in combination to form the aerial image forming portion. The microlens array 40 is placed parallel to the display screen of the display device 12 such that the display screen of the display device 12 is positioned on the object side focal plane of the microlenses forming the microlens array 40. Consequently, a real image of an image (the other party's image) displayed on the display screen of the display device 12 is formed as the aerial image 41 by each microlens of the microlens array 40 at an aerial position (image side focal plane) on the user side with respect to the microlens array 40 (see Patent Document 7). The user 10 sets his visual line to the other party's eyes appeared in the aerial image 41.

As explained in Embodiment 1, it is preferable that the camera 11 is placed at a position where the angle (deviation angle) θ between the visual line direction 19 of the user 10 and the shooting direction 18 of the camera 11 becomes as small as possible. Thus, in the present embodiment, the camera 11 can be placed, for example, at or near one of the surrounding edges (the upper edge in FIG. 5) of the microlens array 40. This allows a cabinet (not shown) for holding the display device 12 and the microlens array 40 to also hold the camera 11, so that an all-in-one teleconference system can be achieved.

As in Embodiment 1, the deviation angle θ between the visual line direction 19 of the user 10 and the shooting direction 18 of the camera 11 cannot be eliminated completely also in the present embodiment. However, in comparison with the conventional teleconference system shown in FIG. 6A, the camera 11 can be placed at a position situated farther than the position for forming the aerial image 41 in which the other party's image appears. Thus, in the present embodiment, it is possible to reduce the deviation angle θ between the visual line direction 19 of the user 10 and the shooting direction 18 of the camera 11 more easily than in the conventional system (FIG. 6A).

Further, the camera 11 shoots the user 10 directly. Thus, the problems associated with the conventional teleconference systems shown in FIGS. 7A and 7B, such as the amount of incident light to the camera being small and the color of images shot by the camera being unnatural, do not arise in the present embodiment, so that it is possible to shoot bright and natural-colored images of high picture quality.

In the area in which the aerial image 41 is formed, there is no obstacle to the camera 11 in shooting the user 10. Therefore, the camera 11 can shoot the user 10 though the area in which the aerial image 41 is formed. This makes it possible to further reduce the deviation angle θ.

The position at which the aerial image 41 is formed in the visual line direction 19 of the user 10 can be adjusted by changing the focal distance of the microlenses forming the microlens array 40. For example, if microlenses all having the same shape are formed on both sides of the microlens array 40 to coincide the image side focal distance with the object side focal distance, the aerial image 41 is formed at a position plane-symmetrical to the display screen of the display device 12 with respect to the microlens array 40. On the other hand, if the image side focal distance is set to be larger than the object side focal distance by, for example, making the radius of curvature of each microlens on the user 10 side surface of the microlens array 40 larger than that of each microlens on the display device 12 side surface, the spacing between the microlens array 40 and the aerial image 41 can be increased without changing the spacing between the microlens array 40 and the display device 12. This makes it possible to further reduce the deviation angle θ.

The effects of Embodiment 3 will be described by way of a specific numerical example.

Consideration is given to the following teleconference system; in this teleconference system, when having a conference, the user looks at the other party's image displayed in an image display area that is 50 cm apart from the user in the horizontal direction and is parallel to the vertical direction. The aspect ratio and the diagonal size of the image display area are 16:9 and 26 inches, respectively. The vertical position of the other party's eyes displayed in the image display area is 5 cm below the upper edge of the image display area, and the user sets his visual line to the other party's eyes displayed.

To configure the above-described teleconference system in the present embodiment, the aerial image 41 may be formed at a position 50 cm apart from the user 10 in FIG. 5. The vertical position of the upper edge of the microlens array 40 is the same as or higher than that of the upper end of the area in which the aerial image 41 is formed. The alternate long and two short dashes line 48 indicates a horizontal plane passing the upper end of the area in which the aerial image 41 is formed. The camera 11 is placed at the upper edge of the microlens array 40. Given that the vertical position at which the cameral 11 is placed is the same as that of the upper end of the area in which the aerial image 41 is formed and that a spacing of 46 cm or more is ensured between the microlens array 40 and the aerial image 41, the deviation angle θ can be reduced to 3° or less, at which the user would feel substantially no visual line difference (tan⁻¹ [5/(50+46)]=2.98°).

In the microlens array 40, there is generally an area with no microlens around the area in which a plurality of microlenses are formed. Thus, in reality, the vertical position at which the camera 11 is placed may need to be set higher than the horizontal plane 48 passing the upper end of the area in which the aerial image 41 is formed. Even in such a case, it is possible to adequately reduce the deviation angle θ to 3° or less by increasing the spacing between the microlens array 40 and the aerial image 41 (i.e., the image side focal distance of the microlens array 40).

Therefore, according to the present embodiment, it is possible to achieve a teleconference system in which the user feels no feeling of strangeness resulting from a visual line difference.

In the numerical example described above, the spacing between the microlens array 40 and the display device 12 can be set as needed by changing the object side focal distance of the microlens array 40.

As with the teleconference system 1 according to Embodiment 1, the teleconference system 3 according to the present embodiment can be used to have a teleconference between distant locations as described above with reference to FIG. 3 by placing the teleconference system 3 in each of conference rooms that are distant from each other.

Further, a touch input device similar to the one described in Embodiment 2 can be added also to the teleconference system 3 according to the present embodiment.

The aerial image forming portion of the teleconference system of the present invention is not limited to the reflective imaging element 20 as described in Embodiments 1 and 2 and to the microlens array 40 as described in Embodiment 3. It is possible to use any components capable of forming, as an aerial image in space, an image of the other party's image displayed on the display device 12.

The aerial image is not limited to a two dimensional image and it may be a three dimensional image.

The above-described embodiments are intended merely to clarify the technical content of the present invention. The present invention is not to be construed as being limited to these specific examples, but is to be construed in a broad sense, and may be practiced with various modifications within the sprit and the scope of the claims.

### INDUSTRIAL APPLICABILITY

The present invention can be used as a teleconference system used for having a conference between distant locations.

### DESCRIPTION OF REFERENCE NUMERALS

1, 2, 3 teleconference system
10 user
11 camera
12 display device
20 reflective imaging element (aerial image forming portion)
21 aerial image
30 touch input device
40 microlens array (aerial image forming portion)
41 aerial image

1. A teleconference system comprising a camera for shooting a user and a display device for displaying other party's image,
wherein the teleconference system further comprises an aerial image forming portion for forming, as an aerial image in space, an image of the other party's image displayed on the display device, and
the camera is placed at a position situated farther than the aerial image from the user.

2. The teleconference system according to claim 1, wherein the camera is placed at or near an edge of the aerial image forming portion.

3. The teleconference system according to claim 1, wherein the camera shoots the user through an area in which the aerial image is formed.

4. The teleconference system according to claim 1, wherein the aerial image forming portion comprises a reflective imaging element for forming the image of the other party's image displayed on the display device at a position plane-symmetrical to the other party's image.

5. The teleconference system according to claim 1, wherein the aerial image forming portion comprises a microlens array placed between the display device and the user, and the microlens array forms, on the opposite side to the display device, the image of the other party's image displayed on the display device.

6. The teleconference system according to claim 1, further comprising a touch input device placed between the aerial image forming portion and the user.
